(19) United States
(12) Patent Application Publication
(10) Pub. No.: US 2020/0142241 A1
(43) Pub. Date: May 7, 2020

(54) LIQUID CRYSTAL PANEL AND DISPLAY DEVICE

(71) Applicant: Huizhou China Star Optoelectronics Technology, Huizhou Guangdon (CN)

(72) Inventor: Xiaohong JING, Huizhou Guangdong (CN)

(21) Appl. No.: 15/749,495

(22) PCT Filed: Jan. 24, 2018
(86) PCT No.: PCT/CN2018/073982

§ 371 Date: Jan. 31, 2018

(30) Foreign Application Priority Data
Dec. 28, 2017 (CN) 201711460913.1

(51) Int. Cl. G02F 1/1345; G02F 1/1335; G02F 1/1339

(52) U.S. Cl. CPC G02F 1/13458; G02F 1/13452; G02F 1/1368; G02F 1/1339; G02F 1/133528; G02F 1/133514

(57) ABSTRACT

The present disclosure discloses a liquid crystal panel, including a TFT substrate, a sealant, a CF substrate, liquid crystal, a lead wire, and a bonding terminal. The present disclosure further discloses a display device. The liquid crystal panel uses the CF substrate and the polarizer thereon as the viewing surface, the side wire of the TFT without printing process, the bonding terminal of the liquid crystal panel is arranged on the back surface of the TFT substrate through the lead wire, the CF of the front side of the TFT protrude the top of the TFT and the offset thereof are enlarged to eliminate the step difference of the front surface of the TFT, so that the CF substrate and the upper partial has the appearance, followed by narrowing the width of the front of the lead area to increase the visibility of the screen area ratio.

### RELATED APPLICATIONS

The present application is a National Phase of International Application Number PCT/CN2018/073982, filed Jan. 24, 2018, and claims the priority of China Application No. 201711460913.1, filed Dec. 28, 2017.

### FIELD OF THE DISCLOSURE

The present disclosure relates to a liquid crystal display technology field, and more particularly to a liquid crystal panel and a display device.

### BACKGROUND OF THE DISCLOSURE

Bezel Less LCD gradually become a popular design trend, borderless display refers to the screen frame extremely narrow display device, the screen will be combined with the display screen and the border resulting in the visual design can not see the physical border. One of its major advantages is the outstanding appearance, compared with the past with a thick border of the display, no border can bring a real sense of the horizontal screen, so that the appearance of a more stylish. Another big advantage is that the display without borders technology can achieve good display splicing, to achieve two-screen, triple screen or even multi-screen, and no border monitor can maximize the effect of the display screen. In addition, the borderless display gives the user a wider viewing angle and eliminates the bondage of the original thick border display.

At present, a common bezel less design of a liquid crystal display is extended a color filter (CF) substrate on a side of an array (Thin Film Transistor array, TFT) substrate disposed at a lower end in a liquid crystal panel and the extending area is disposed a bonding terminal to connected to a printed circuit board through a driving chip. Since a bonding area line device may cause a reflective problem after the bonding, the extending area needs to be printed, which makes the borderless liquid crystal panel process complicated and increases the production cost. In addition, since the bonding terminal generally needs a certain width, the bonding terminal of the bonding surface in the view plane exists and is wide in width, which reduces user experience even though there is no physical border visually in this case.

### SUMMARY OF THE DISCLOSURE

In view of the defects of the prior art, the present disclosure provides a liquid crystal panel and a display device to provide a low cost, bezel less liquid crystal panel.

In order to achieve the above object, the present disclosure adopts the following technical solutions.

The present disclosure provides a liquid crystal panel, including a TFT substrate, a sealant surrounding an edge of an upper surface of the TFT substrate, a CF substrate covering on the sealant, and liquid crystal injected into an inner side of the sealant, and further including a lead wire, same side end surfaces of the TFT substrate and the CF substrate are all protrude the corresponding side end surfaces of the sealant, one end of the lead wire is connected to an electrode line of an upper surface of an protruded portion of the TFT substrate, and the other end of the lead wire is bent and led out to a back surface of the TFT substrate to form a bonding terminal.

Wherein a protruding length of the CF substrate is not less than a protruding length of the TFT substrate so that the CF substrate completely shields the TFT substrate.

Wherein a first polarizer and a second polarizer are respectively attached to an outer surface of the TFT substrate and the CF substrate, the first polarizer completely covers an outer surface of the CF substrate, the second polarizer is attached to the outer surface of the TFT substrate and adjacent to the bonding terminal.

Wherein an encapsulant is filled between a protruded portion of the TFT substrate and a protruded portion of the CF substrate.

Wherein a surface of the protruded portion of the CF substrate opposite to the TFT is provided with a groove, and the groove is filled with the encapsulant.

Wherein the lead wire abuts an outer surface of the TFT substrate.

Wherein the lead wire is printed or etched on a surface of the TFT substrate.

The present disclosure further provides a display device, including a backlight module and the liquid crystal panel, the backlight module is disposed on a side of the TFT substrate away from the CF substrate, and light emitted from the backlight module is emitted from a surface of the CF substrate through the TFT.

Compared with the prior art, the liquid crystal panel provided by the present disclosure uses the CF substrate and the polarizer thereon as the viewing surface, and the TFT substrate does not need to be everted. Therefore, the problem of reflectiveness on the TFT side of the circuit does not need to be printed, reducing the cost, and the bonding terminal of the liquid crystal panel is arranged on the back surface of the TFT substrate through the lead wire, the CF of the front side of the TFT protrudes the top of the TFT and the offset thereof are enlarged to eliminate the step difference of the front surface of the TFT. So that the CF substrate and the upper bias has the appearance, followed by narrowing the width of the front lead area, can increase the proportion of the screen to go to enhance the user experience.

### BRIEF DESCRIPTION OF THE DRAWINGS

FIG. 1 is a schematic structural diagram of an embodiment of a liquid crystal panel of the present disclosure.

FIG. 2 is an enlarged diagram of part I in FIG. 1.

FIG. 3 is a schematic structural diagram of another embodiment of the liquid crystal panel of the present disclosure.

FIG. 4 is an enlarged schematic diagram of part II of FIG. 1.

FIG. 5 is a schematic structural diagram of the display device of the present disclosure.

### DETAILED DESCRIPTION OF PREFERRED EMBODIMENTS

In order to make the objectives, technical solutions and advantages of the present disclosure more comprehensible, the present disclosure is further described in detail below with reference to the accompanying drawings and embodiments. It should be understood that the specific embodiments described herein are merely used to explain the present disclosure, and are not intended to limit the present disclosure.

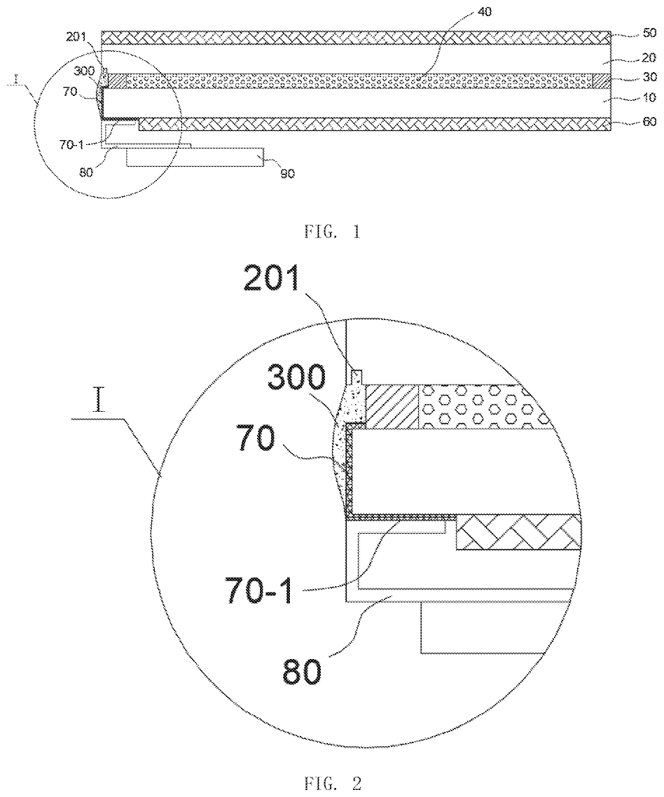

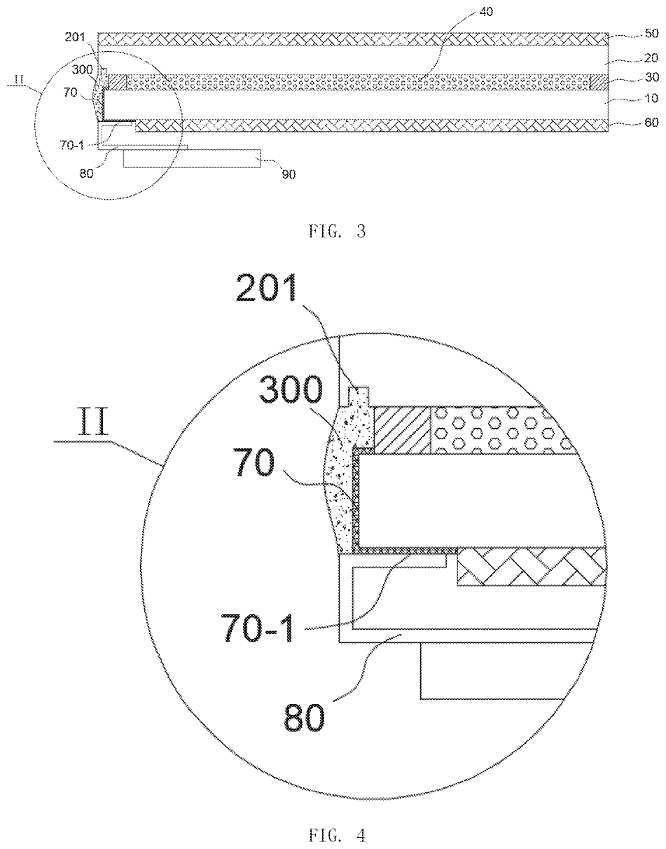

Referring to FIG. 1 and FIG. 3, a liquid crystal panel of the present disclosure, including a TFT (Thin Film Transistor) substrate 10 opposite to the backlight module, a sealant 30 disposed on an upper surface of the TFT substrate 10, and a CF substrate 20 covering the sealant 30. Liquid crystal 40 is disposed in the sealant 30 between the TFT substrate 10 and the CF substrate 20. It can be understood that the area provided with the liquid crystal 40 forms the display area of the liquid crystal panel, wherein the same side surface of the TFT substrate 10 and the CF substrate 20 is protrudes the side end surface of the sealant 30 and the lead wire 70 is electrically connected to the upper surface of the protruded portion of the TFT substrate 10. After the lead wire 70 is bent, a bonding terminal 10-1 for connecting the COF80 is formed on the back surface of the TFT substrate 10. The bonding terminal 10-1 is provided with a conductive terminal so that the COF80 is electrically connected with the conductive terminal.

As Embodiment 1 of the present disclosure, referring to FIG. 1 and FIG. 2, the protruding length of the CF substrate 20 is equal to the protruding length of the TFT substrate 10, and the shape of the CF substrate 20 is the same as the shape of the TFT substrate 10 so that the CF substrate 20 at the upper end of the TFT substrate 10 covers the TFT substrate 10.

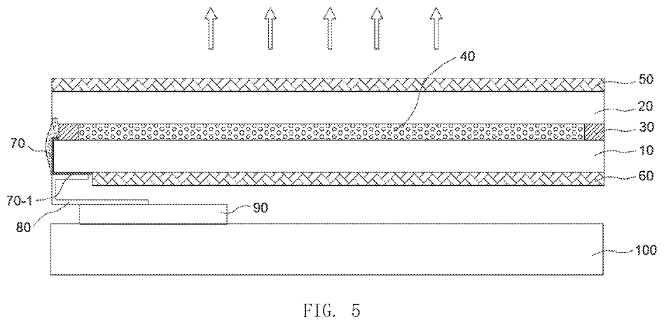

As another embodiment of the present disclosure, in the first embodiment, since the protruding length of the CF substrate 20 is equal to the protruding length of the TFT substrate 10, when the lead wire 70 connected to the portion of the TFT substrate 10 is not attached to the surface of the TFT substrate 10, the lead wire 70 is exposed to the outer end surface of the TFT substrate 10 and the lead wire 70 is easily damaged. Therefore, based on the above embodiment, the present embodiment is further improved. Referring to FIG. 3 and FIG. 4, the protruding length of the CF substrate 20 is slightly larger than the protruding length of the TFT substrate 10, so that the lead wire 70 can be disposed within the extra length of the CF substrate 20. In this way, the lead wire 70 can be protected while minimizing non-display over-length. It can be understood that the CF substrate 20 not only covers the TFT substrate 10 completely covering the lower end but also extends beyond the TFT substrate 10 at the end where the lead wire 70 is disposed so that the protruded portion protects the lead wire 70.

Referring to FIG. 1 and FIG. 3, the first polarizer 50 and the second polarizer 60 are respectively attached to the outer surfaces of the TFT substrate 10 and the CF substrate 20. The first polarizer 50 completely covers the outer surface of the CF substrate 20. In this case, the first polarizer 50 is the outermost viewing surface and completely covers the lower TFT substrate 10. The second polarizer 60 is attached to the outer surface of the TFT substrate 10. Understandably, the second polarizer 60 is attached to the outer surface of the TFT substrate 10 except for the bonding terminal 10-1 after the lead wire 70 is bent and attached to the outer surface of the TFT substrate 10 to form the bonding terminal 10-1.

Specifically, after the lead wire 70 is led out, the side of the liquid crystal panel needs to be encapsulated, that is, the cavity formed between the CF substrate 20 and the protruded portion of the TFT substrate 10 is filled. The filling can be performed in various ways. For example, the encapsulant 300 is encapsulated by injecting the encapsulant 300 from the side of the cavity, and the encapsulant 300 partially encapsulates the lead wire 70 at the side end of the TFT substrate 10 to protect the lead wire 70.

In order to make a more secure connection between the upper and lower substrates, a groove 201 may be provided on the lower surface of the protruded portion of the CF substrate 20, in the above packaging process, the groove 201 can be filled with the encapsulant 300 so as to realize the fastening connection of the upper substrate and the lower substrate. In this way, the protruding length of the upper and lower substrates can be effectively reduced without affecting the fastening connection between the upper and lower substrates, so that the screen area ratio of the visible area can be increased.

Specifically, the purpose of the lead wire 70 is to design the bonding terminal, which must be originally designed on the upper surface of the TFT substrate 10, to the lower surface of the TFT substrate 10 through the lead wire 70 so that the width of the upper surface can be reduced. Therefore, the lead wire 70 can be connected to the COF80 after it is led out, the lead wire 70 is closely attached to the outer surface of the TFT substrate 10, that is, the lead wire 70 extends from the upper surface of the portion protrude the TFT substrate 10 to the side of the TFT substrate 10 up to the back surface of the TFT substrate 10 for the sake of compactness and good appearance. Wherein the lead wires 70 are printed or etched on the surface of the TFT substrate 10.

Referring to FIG. 5, correspondingly, the display device in the present embodiment includes a backlight module 100 and the liquid crystal panel described above. The backlight module 100 is disposed on a side of the TFT substrate 10 facing away from the CF substrate 20, the light emitted from the backlight module 100 is emitted from the surface of the CF substrate 20 after passing through the TFT substrate 10. The COF80 includes a flexible circuit board and a driver IC (integrated circuit) on the flexible circuit board. The LCD panel is connected to the PCB 90 through the flexible circuit board of the COF80.

The liquid crystal panel of the embodiment uses the CF substrate and the polarizer thereon as the viewing surface, and the TFT substrate does not need to be everted. Therefore, the problem of reflectiveness on the TFT side of the circuit does not need to be printed and the cost is reduced, and the bonding terminal of the liquid crystal panel is arranged on the back surface of the TFT substrate through the lead wire, the CF of the front side of the TFT protrudes the top of the TFT and the offset thereof are enlarged to eliminate the step difference of the front surface of the TFT, so that the CF substrate and the upper partial has the appearance, followed by narrowing the width of the front of the lead area to increase the viewing area of the screen, improve user experience.

The above is only the specific implementation manners of the present application. It should be noted that, for those skilled in the art, several improvements and modifications can be made without departing from the principle of the present disclosure, and these improvements and modifications should also be considered as the protection scope of the present application.

What is claimed is:

1. A liquid crystal panel, comprising a TFT substrate, a sealant surrounding an edge of an upper surface of the TFT substrate, a CF substrate covering on the sealant, and liquid crystal injected into an inner side of the sealant, and further comprising a lead wire, same side end surfaces of the TFT substrate and the CF substrate are all protrude the corresponding side end surfaces of the sealant, one end of the lead wire is connected to an electrode line of an upper surface of a protruded portion of the TFT substrate, and the other end of the lead wire is bent and led out to a back surface of the TFT substrate to form a bonding terminal.

2. The liquid crystal panel according to claim 1, wherein the lead wire abuts an outer surface of the TFT substrate.

3. The liquid crystal panel according to claim 2, wherein the lead wire is printed or etched on a surface of the TFT substrate.

4. The liquid crystal panel according to claim 1, wherein a protruding length of the CF substrate is not less than a protruding length of the TFT substrate so that the CF substrate completely shields the TFT substrate.

5. The liquid crystal panel according to claim 4, wherein a first polarizer and a second polarizer are respectively attached to an outer surface of the TFT substrate and the CF substrate, the first polarizer completely covers an outer surface of the CF substrate, the second polarizer is attached to the outer surface of the TFT substrate and adjacent to the bonding terminal.

6. The liquid crystal panel according to claim 5, wherein an encapsulant is filled between a protruded portion of the TFT substrate and a protruded portion of the CF substrate.

7. The liquid crystal panel according to claim 6, wherein the lead wire abuts an outer surface of the TFT substrate.

8. The liquid crystal panel according to claim 6, wherein a surface of the protruded portion of the CF substrate opposite to the TFT is provided with a groove, and the groove is filled with the encapsulant.

9. The liquid crystal panel according to claim 8, wherein the lead wire abuts an outer surface of the TFT substrate.

10. The liquid crystal panel according to claim 9, wherein the lead wire is printed or etched on a surface of the TFT substrate.

11. A display device, comprising a backlight module and a liquid crystal panel, wherein the liquid crystal panel comprises a TFT substrate, a sealant surrounding an edge of an upper surface of the TFT substrate, a CF substrate covering on the sealant, and liquid crystal injected into an inner side of the sealant, and further comprising a lead wire, same side end surfaces of the TFT substrate and the CF substrate are all protrude the corresponding side end surfaces of the sealant, one end of the lead wire is connected to an electrode line of an upper surface of an protruded portion of the TFT substrate, and the other end of the lead wire is bent and led out to a back surface of the TFT substrate to form a bonding terminal, the backlight module is disposed on a side of the TFT substrate away from the CF substrate, and light emitted from the backlight module is emitted from a surface of the CF substrate through the TFT.

12. The display device according to claim 11, wherein the lead wire abuts an outer surface of the TFT substrate.

13. The display device according to claim 12, wherein the lead wire is printed or etched on a surface of the TFT substrate.

14. The display device according to claim 11, wherein a protruding length of the CF substrate is not less than a protruding length of the TFT substrate so that the CF substrate completely shields the TFT substrate.

15. The display device according to claim 14, wherein a first polarizer and a second polarizer are respectively attached to an outer surface of the TFT substrate and the CF substrate, the first polarizer completely covers an outer surface of the CF substrate, the second polarizer is attached to the outer surface of the TFT substrate and adjacent to the bonding terminal.

16. The display device according to claim 15, wherein an encapsulant is filled between a protruded portion of the TFT substrate and a protruded portion of the CF substrate.

17. The display device according to claim 16, wherein the lead wire abuts an outer surface of the TFT substrate.

18. The display device according to claim 16, wherein a surface of the protruded portion of the CF substrate opposite to the TFT is provided with a groove, and the groove is filled with the encapsulant.

19. The display device according to claim 18, wherein the lead wire abuts an outer surface of the TFT substrate.

20. The display device according to claim 19, wherein the lead wire is printed or etched on a surface of the TFT substrate.
